(19) United States
(12) Patent Application Publication
(10) Pub. No.: US 2021/0060897 A1
(43) Pub. Date: Mar. 4, 2021

(54) FOAM PRODUCTS HAVING MAGNETIC MATERIALS ENCAPSULATED THEREIN

(71) Applicant: SINOMAX-USA, INC., Houston, TX (US)

(72) Inventor: John Austin BELIVEAU, Mooresville, NC (US)

(21) Appl. No.: 17/003,607

(22) Filed: Aug. 26, 2020

Related U.S. Application Data
(60) Provisional application No. 62/892,267, filed on Aug. 27, 2019.

(51) Int. Cl. B32B 5/32; A47C 31/00; A47C 27/15; A47C 27/08; A47C 27/00; C08J 9/40; C08K 9/10; C08K 7/00; B32B 7/12

(52) U.S. Cl. CPC B32B 5/32; B32B 2305/022; A47C 27/15; A47C 27/088; A47C 27/002; C08J 9/40; C08K 9/10; C08K 7/00; B32B 7/12; C08K 2201/01; C08J 2205/06; B32B 2250/22; B32B 2479/00; B32B 2307/208; A47C 31/003

(57) ABSTRACT

Embodiments of the present disclosure relate to a magnetic body support product, such as a foam mattress topper or a foam pillow, having a plurality of magnets encapsulated therein. In one embodiment, the magnetic body support product includes a first foam layer, a second foam layer secured to the first foam layer, and a plurality of flexible magnetic materials encapsulated by the first foam layer and the second foam layer. The flexible magnets provide health benefits to a user laying on the magnetic. The first foam layer and the second foam layer enable the user to lay on either side of the magnetic body support product without feeling the plurality of magnetic materials.

### CROSS-REFERENCE TO RELATED APPLICATIONS

This application claims benefit U.S. Provisional Patent Application No. 62/892,267, filed on Aug. 27, 2019, which application is incorporated by reference herein in its entirety.

### BACKGROUND

### Field

Embodiments of the present disclosure generally relate to body support products formed from foam materials. In particular, embodiments of the disclosure relate to a magnetic body support product, such as a foam mattress topper or a foam pillow, having a plurality of magnetic materials encapsulated therein.

### Description of the Related Art

Conventional body supports can be found in a wide variety of shapes and sizes, and are often adapted for supporting one or more parts of a user's body. Examples of body supports include mattresses, pillows, and other cushion-type products. Many body supports are generally constructed out of foam materials, such as polyurethane foam. The foam materials may include visco-elastic properties, such foam materials being known in the art as “memory foam,” which provides the body support with an increased ability to conform to a user and thereby distribute the weight of the user.

Magnets have been incorporated in body support products to provide health benefits to a user. The benefits include relieving pain, enhancing sleeping quality, and boosting immune system. However, a convention magnetic body support product has magnets disposed under the body support portion of the product, such as under a foam support of a foam mattress pad, so the user does not feel the magnets when laying on the body support product. Thus, a user can only lay on one side of the conventional magnetic body support product. The usage of the conventional magnetic body support product is limited to one side.

Therefore, an improved magnetic body support product is needed.

### SUMMARY

Embodiments of the present disclosure generally relate to body support products formed from foam materials. In particular, embodiments of the disclosure relate to a magnetic body support product, such as a foam mattress topper or a foam pillow, having a plurality of magnetic materials encapsulated therein. In one embodiment, the magnetic body support product includes a body support having a top surface and a bottom surface, and a plurality of magnetic materials encapsulated in the body support. The plurality of magnetic materials is about a first distance away from the top surface and a second distance away from the bottom surface. The first distance ranges from about 1 in to about 5 in and the second distance ranges from about 1 in to about 5 in.

In another embodiment, the magnetic body support product includes a first foam layer having a top surface, a second foam layer having a bottom surface, and a plurality of magnetic materials encapsulated in the first and second foam layers. The plurality of magnetic materials is about a first distance away from the top surface and a second distance away from the bottom surface. The first distance ranges from about 1 in to about 5 in and the second distance ranges from about 1 in to about 5 in.

In another embodiment, the magnetic body support product includes a foam layer having a top surface and a bottom surface, and a plurality of magnetic materials encapsulated in the foam layer. The plurality of magnetic materials is about a first distance away from the top surface and a second distance away from the bottom surface. The first distance ranges from about 1 in to about 5 in and the second distance ranges from about 1 in to about 5 in.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a magnetic body support product according to one embodiment.

FIG. 2A illustrates a cross-sectional view of the magnetic body support product of FIG. 1 according to one embodiment.

FIG. 2B illustrates a cross-sectional view of the magnetic body support product of FIG. 1 according to another embodiment.

FIG. 3 illustrates a magnetic material utilized in the magnetic body support product of FIG. 1 according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to a magnetic body support product, such as a foam mattress topper or a foam pillow, having a plurality of magnets encapsulated therein. In one embodiment, the magnetic body support product includes a first foam layer, a second foam layer secured to the first foam layer, and a plurality of flexible magnetic materials encapsulated by the first foam layer and the second foam layer. The flexible magnets provide health benefits to a user laying on the magnetic. The first foam layer and the second foam layer enable the user to lay on either side of the magnetic body support product without feeling the plurality of magnetic materials.

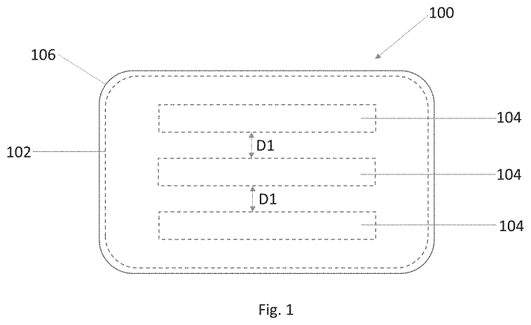

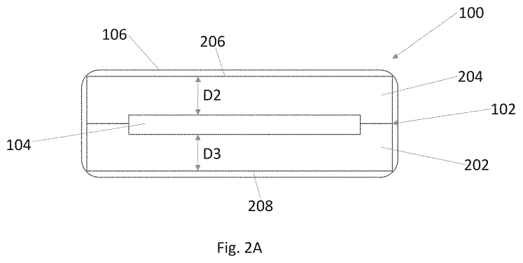

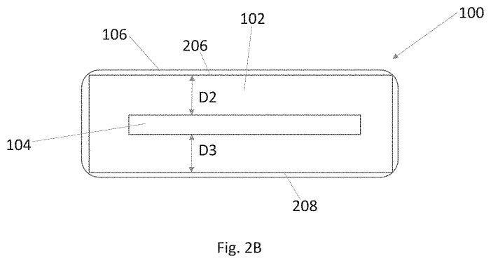

FIG. 1 illustrates a magnetic body support product 100 according to one embodiment. As shown in FIG. 1, the magnetic body support product 100 includes a body support 102, a plurality of magnetic materials 104 encapsulated in the body support 102, and a removable cover 106 enclosing the body support 102. The magnetic body support product 100 may be a mattress topper, a pillow, or other suitable magnetic body support product. The body support 102 may be a foam pad, a foam pillow, a foam cushion, or any suitable foam body support. Examples of the body support 102 are described in detail in FIGS. 2A and 2B below.

Examples of the plurality of magnetic materials 104 include flexible magnets, flexible material having magnetic regions, or other suitable magnetic material. Exemplary flexible magnets include ferrite magnets, rare earth magnets, or other suitable flexible magnets. Each magnetic material 104 may be spaced apart from an adjacent magnetic material 104. For example, adjacent magnetic materials spaced apart by a distance of D1, which may range from about 0.015 in to about 80 in. The shape of the magnetic material 104 may be any suitable shape, such as rectangular, circular, triangular, regular or irregular polygonal. In some embodiments, the body support 102 is fabricated from a foam material that is not washable, and the removable cover 106 is utilized to protect the body support 102 from getting dirty. The removable cover 106 may be fabricated from any suitable material, such as cotton, that is washable.

FIG. 2A illustrates a cross-sectional view of the magnetic body support product 100 of FIG. 1 according to one embodiment. As shown in FIG. 2A, the magnetic body support product 100 includes the body support 102, the plurality of magnetic materials 104 encapsulated in the body support 102, and an optional removable cover 106 enclosing the body support 102. In one embodiment, the body support 102 includes a first foam layer 202 and a second foam layer 204 disposed on the first foam layer 202. The first foam layer 202 may be secured to the second foam layer 204 by any suitable securing method, such as using an adhesive. The first and second foam layers 202, 204 may be made out of “memory foam” or polyurethane foam having visco-elastic properties. One or both of the foam layers 202, 204 may have a density of about 1-5 lbs/ft³. In one embodiment, the first and second foam layers 202, 204 may have the same density or different densities. The first foam layer 202 includes a bottom surface 208 and the second foam layer 204 includes a top surface 206. The plurality of magnetic materials 104 may be encapsulated by the first and second foam layers 202, 204, and the plurality of magnetic materials 104 may be secured to the first and/or second foam layers 202, 204 by any suitable method, such as using an adhesive. The plurality of magnetic materials 104 may be a distance D2 away from the top surface 206 and a distance D3 away from the bottom surface 208. The distance D2 may be the same as or different from the distance D3. The distances D2 and D3 may each range from about 1 in to about 5 in. The distances D2 and D3 enable a user to lay on either side of the magnetic body support product 100 without feeling the plurality of magnetic materials 104.

Each of the first and second foam layers 202, 204 may have an indention load deflection (“ILD”) rating of about 1-25 lbs, such as about 1-4 lbs, about 1-15 lbs, about 4-15 lbs, about 4-20 lbs, and about 20-25 lbs. In one embodiment, one or both of the first and second foam layers 202, 204 may be infused with a gel material, such as a polyurethane based gel. The gel material may comprise polyether or polyol. The gel material may be in the form of particles or beads embedded in the first and/or second foam layers 202, 204. The gel material may be a polymer such as elastomeric polymers, thermosetting polymers, thermoplastic elastomers, and combinations thereof. Suitable gels include polyurethane gels, silicone gels, PVC gels, polyorganosiloxane gels, polyol gels, polyisocyanate gels, and combinations thereof. The gel material may provide additional support and/or increase the thermal conductivity of the foam layers 202, 204 to effectively remove or absorb the body heat of a user, thereby providing a cool or colder temperature support than a non-gel-infused layer.

FIG. 2B illustrates a cross-sectional view of the magnetic body support product 100 of FIG. 1 according to another embodiment. As shown in FIG. 2B, the magnetic body support product 100 includes the body support 102, the plurality of magnetic materials 104 encapsulated in the body support 102, and the optional removable cover 106 enclosing the body support 102. In one embodiment, the body support 102 has a monolithic body, and the plurality of magnetic materials 104 is encapsulated in the monolithic body of the body support 102. For example, the body support 102 is a monolithic foam layer fabricated from the same material as the first foam layer 202 or the second foam layer 204 discussed above. The monolithic foam layer with the plurality of magnetic materials 104 encapsulated therein may be fabricated by any suitable method. In one embodiment, the plurality of magnetic materials 104 is suspended in a mold prior to injecting the foam into the mold. For example, a plurality of strings can be used to suspend the magnetic materials 104. After injected foam in the mold forms the foam layer, the plurality of strings are cut, leaving the plurality of magnetic materials encapsulated in the foam layer. The body support 102 includes the top surface 206 and the bottom surface 208. The plurality of magnetic materials 104 is the distance D2 away from the top surface 206 and the distance D3 away from the bottom surface 208.

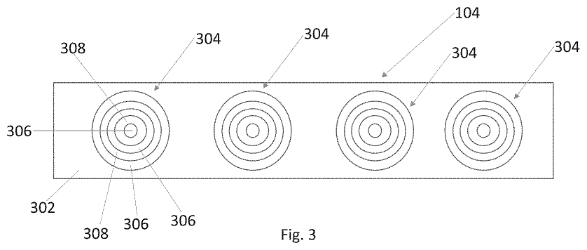

FIG. 3 illustrates the magnetic material 104 utilized in the magnetic body support product 100 of FIG. 1 according to one embodiment. As shown in FIG. 3, the magnetic material 104 may be a strip of flexible material 302 including a plurality of magnetic regions 304 formed therein. The strip of flexible material 302 may be any suitable flexible material, such as vinyl or rubber. The magnetic regions 304 may be formed by embedding magnetic particles, such as barium ferrite or strontium ferrite, in the magnetic regions 304. Each magnetic region 304 may include concentric rings of alternating polarity. For example, a magnetic region 304 includes a first plurality of rings 306 and a second plurality of rings 308 alternating with the first plurality of rings 306. In one embodiment, each of the first plurality of rings 306 may be the south pole and each of the second polarity of rings 308 may be the north pole. In another embodiment, each of the first plurality of rings 306 may be the north pole and each of the second polarity of rings 308 may be the south pole. The adjacent rings 306, 308 have opposite polarity. Each of the concentric annular rings may be continuous or discrete. In one example, each concentric annular ring has a “C” shape. The shape of the magnetic regions 304 is not limited to circular. In some embodiments, each magnetic region 304 includes concentric tubular rectangles having alternating polarities. Each magnetic region 304 may include regions of alternating polarities, and the regions may be arranged in any suitable manner. For example, the magnetic region 304 may include concentric tubular polygonal shaped regions having alternate polarities. The tubular polygonal shaped region may be continuous or discrete. The magnetic material 104 provides health benefits, such as relieving pain, enhancing sleeping quality, and boosting immune system, to a user.

While the foregoing is directed to embodiments of the disclosure, other and further embodiments of the disclosure may be devised without departing from the basic scope thereof, and the scope thereof is determined by the claims that follow.

What is claimed is:

1. A magnetic body support product, comprising:
a body support having a top surface and a bottom surface; and
a plurality of magnetic materials encapsulated in the body support, wherein the plurality of magnetic materials is about a first distance away from the top surface and a second distance away from the bottom surface, wherein the first distance ranges from about 1 in to about 5 in and the second distance ranges from about 1 in to about 5 in.

2. The magnetic body support product of claim 1, wherein the first distance is the same as the second distance.

3. The magnetic body support product of claim 1, wherein the first distance is different from the second distance.

4. The magnetic body support product of claim 1, further comprising a removable cover enclosing the body support.

5. The magnetic body support product of claim 4, wherein the removable cover comprises cotton.

6. The magnetic body support product of claim 1, wherein the body support comprises a foam material.

7. A magnetic body support product, comprising:
a first foam layer having a top surface;
a second foam layer having a bottom surface; and
a plurality of magnetic materials encapsulated in the first and second foam layers, wherein the plurality of magnetic materials is about a first distance away from the top surface and a second distance away from the bottom surface, wherein the first distance ranges from about 1 in to about 5 in and the second distance ranges from about 1 in to about 5 in.

8. The magnetic body support product of claim 7, wherein the first distance is the same as the second distance.

9. The magnetic body support product of claim 7, wherein the first distance is different from the second distance.

10. The magnetic body support product of claim 7, further comprising a cover enclosing the body support.

11. The magnetic body support product of claim 7, wherein each of the plurality of magnetic materials comprises a strip of flexible material having a plurality of magnetic regions formed therein.

12. The magnetic body support product of claim 11, wherein each of the plurality of magnetic regions comprises concentric tubular polygon shaped regions having alternate polarities.

13. The magnetic body support product of claim 12, wherein the concentric tubular polygon shaped region comprises annular rings.

14. The magnetic body support product of claim 7, wherein the first foam layer is secured to the second foam layer by adhesive.

15. A magnetic body support product, comprising:
a foam layer having a top surface and a bottom surface; and
a plurality of magnetic materials encapsulated in the foam layer, wherein the plurality of magnetic materials is about a first distance away from the top surface and a second distance away from the bottom surface, wherein the first distance ranges from about 1 in to about 5 in and the second distance ranges from about 1 in to about 5 in.

16. The magnetic body support product of claim 15, wherein the first distance is the same as the second distance.

17. The magnetic body support product of claim 15, wherein the first distance is different from the second distance.

18. The magnetic body support product of claim 15, wherein each of the plurality of magnetic materials comprises a strip of flexible material having a plurality of magnetic regions formed therein.

19. The magnetic body support product of claim 18, wherein each of the plurality of magnetic regions comprises concentric tubular polygon shaped regions having alternate polarities.

20. The magnetic body support product of claim 19, wherein the concentric tubular polygon shaped region comprises annular rings.
